(19) United States
(12) Patent Application Publication
(10) Pub. No.: US 2004/0032525 A1
(43) Pub. Date: Feb. 19, 2004

(54) Video camera with multiple fields of view

(76) Inventor: Oren Aharon, Haifa (IL)

Correspondence Address: BROWDY AND NEIMARK, P.L.L.C., 624 NINTH STREET, NW, SUITE 300, WASHINGTON, DC, 20001-5303, US

(21) Appl. No.: 10/434,465

(22) Filed: May 9, 2003

Related U.S. Application Data
(60) Provisional application No. 60/378,646, filed on May 9, 2002.

(51) Int. Cl. H04N 5/232

(52) U.S. Cl. 348/350

(57) ABSTRACT

A method and apparatus for generating a video signal representing an image of a scene, by: providing a photodetector having a light sensitive surface with a given area; providing a first focusing lens; positioning the first lens to focus an image of a scene on the photodetector so that only a portion of the image is focused on the light sensitive surface; and effecting relative displacement between the first lens and the photodetector parallel to the light sensitive surface in order to change the portion of the image that is focused on the light sensitive surface.

### BACKGROUND OF THE INVENTION

The present invention relates to video cameras and methods for generating video image signals.

### BRIEF SUMMARY OF THE INVENTION

According to the present invention, video signals representing images of multiple fields of view of a scene are generated by providing two or more lenses and a photodetector array wherein the lenses form images in a common plane containing the photodetector array and at least one of the lenses has an image formation area substantially larger than the area of the photodetector array, and effecting relative movement between the lenses and the photodetector array in a direction parallel to the common plane.

### BRIEF DESCRIPTION OF THE DRAWING

FIGS. 1 and 2 are simplified perspective views showing the basic components of two embodiments of the invention.

FIG. 3 is a pictorial view of a system containing a video camera according to the invention.

FIG. 3A is an elevational, cross-sectional view of a practical embodiment of the invention.

### DETAILED DESCRIPTION OF THE INVENTION

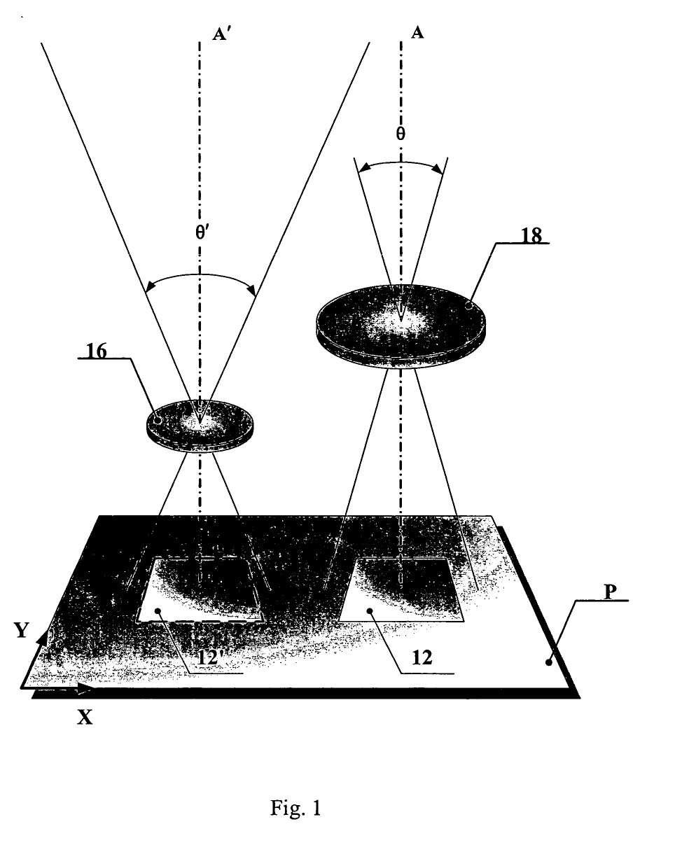

FIG. 1 is a perspective view illustrating a first preferred embodiment of the invention. This embodiment includes a photodetector 12, which is shown in a first position in solid lines and, at 12′, in a second position in broken lines. Photodetector 12 is mounted for movement over a plane P to positions other than those illustrated. [Note: It is not clear from the disclosure whether the entire photodetector is represented by the reference SP or by the reference P. Please clarify this point.]

Above plane P there are disposed two lenses, a relatively short focal length lens 16 and a relatively long focal length lens 18. When lens 18 is positioned to focus an image of a scene on plane P, this image will cover an area larger then the area of detector 12, so that only a portion of that scene will be detected. By moving detector 12 in plane P, different portions of the scene being viewed by lens 18 can be imaged on detector 12.

The focal length of lens 16 can be selected to have a field of view which is such that when detector 12 is in position 12′ aligned with the optical axis of lens 16, substantially the entire field of view of lens 16 is imaged on the detector area.

Thus, by shifting detector 12 in plane P, a scene can be viewed with different magnifications and, when detector 12 is in the field of view of lens 18, different portions of the scene can be imaged by displacing detector 12 in plane P.

One advantage of this arrangement is that the scene imaged on detector 12 by lens 18 is, in effect, an enlarged view of a portion of a scene that will be imaged by lens 16 on detector 12, but with the same resolution as the scene imaged by lens 16.

When detector 12 is displaced within the field of view of the longer focal length lens 18, the result corresponds to pan and tilt scanning. In addition, it is possible to capture and store images of a plurality of regions in the field of view of the longer focal length lens 18.

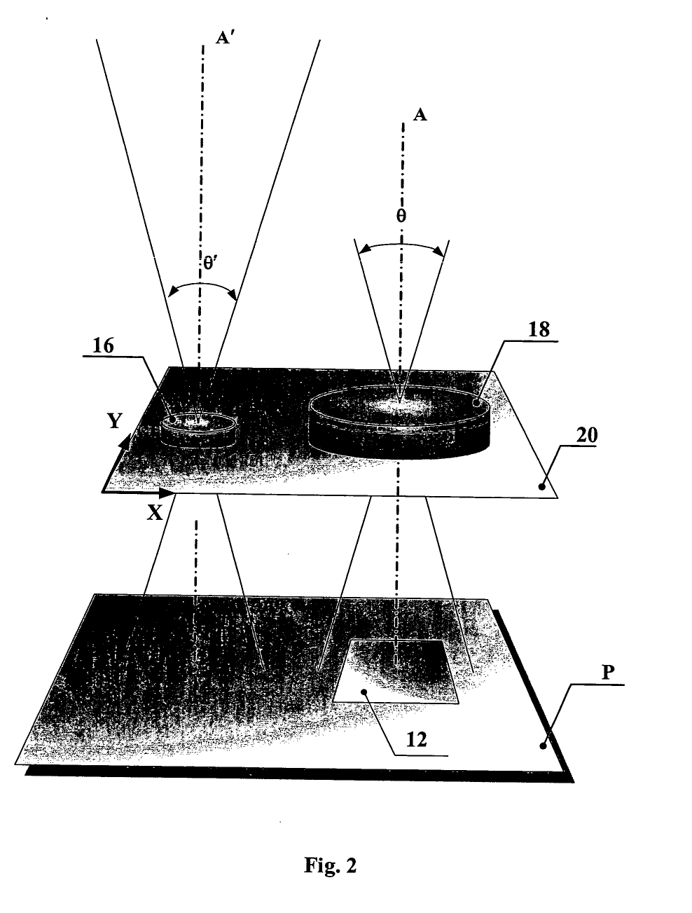

FIG. 2 is a view similar to that of FIG. 1 showing essentially the same structural arrangement, with the exception that detector 12 is essentially maintained stationary and lenses 16 and 18 are mounted on a carriage 20 that is movable in a plane parallel to plane P.

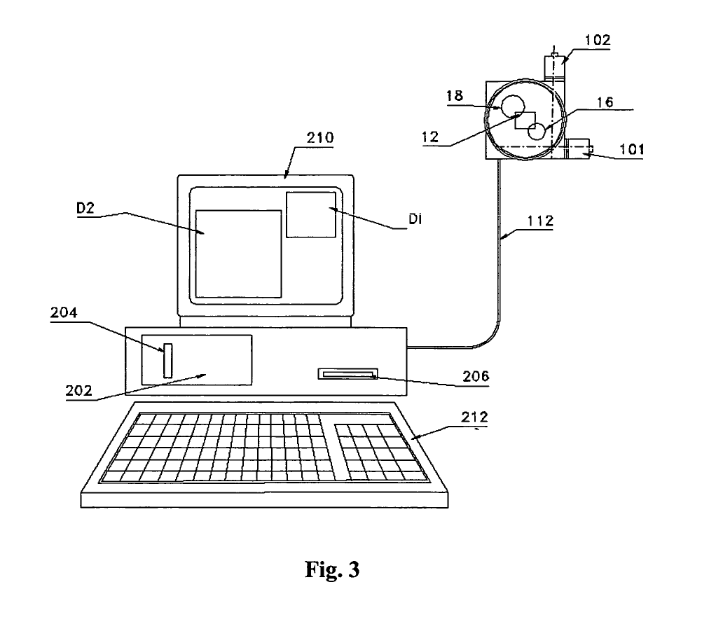

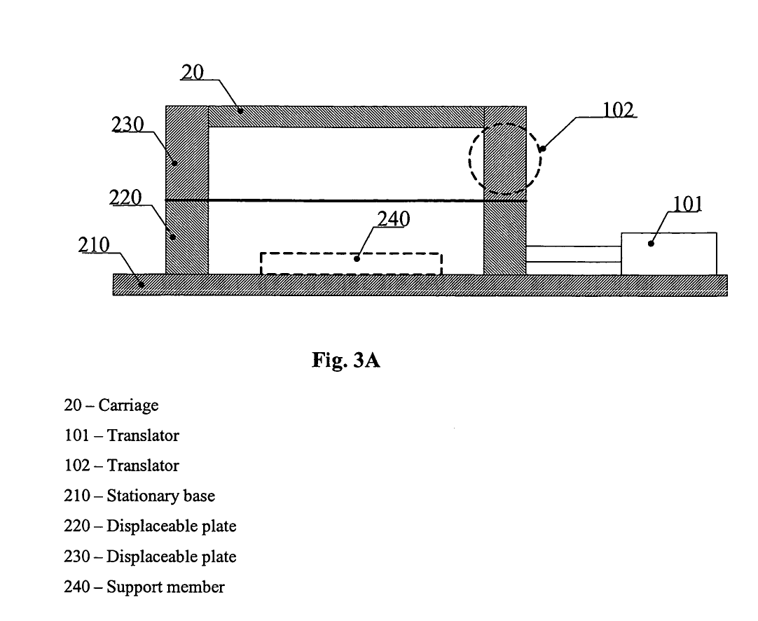

Of course, it would also be possible to mount detector 12 and carriage 20 so that each is movable relative to some fixed reference. In an embodiment of this type, which will be described below with reference to FIG. 3A and which combines the techniques described above with respect to FIGS. 1 and 2, detector 12 can be displaced along one of the X and Y axes, while the lenses are displaced along the other axis. This facilitates fast changes in the fields of view of the lenses and allows the detector 12 to be brought more rapidly to a particular region in the field of view of one of the lenses.

In addition, in the case of each illustrated embodiment, lenses 16 and 18 can be readily mounted for movement perpendicular to plane P for focusing purposes.

FIG. 3 is a perspective view showing a scanning camera according to FIG. 1 or 2, associated with a conventional computer system that can be used for display and editing of images viewed by the camera.

In the illustrated embodiment, carriage 20 is mounted for translational movement relative to detector 12. For this purpose, there may be provided, in a conventional manner, a support base supporting a first plate that is movable by a translator 101 in a first direction parallel to the base, and a second plate that is movable by a translator 102 relative to the first plate in a second direction perpendicular to the first direction. Carriage 20 may be fixed to the second plate and detector 12 may be fixed either to the support base or to the first plate.

Each of translators 101 and 102 may be constituted by a servomotor driving a conventional feed screw mechanism.

The video camera is connected to the computer system via a data line 112, which may be a bus, cable or any other type of data conductor. The computer system constitutes, in effect, a transformation and display device and may be constituted by a conventional personal computer having appropriate software.

The computer system preferably includes a frame grabber 202, a CPU chip 204, a diskette drive 206, a monitor 210 and a keyboard 212. As is conventional, the computer system may also include other storage devices, such as hard drives, CD drives, communications devices such as modems, sound cards, etc.

FIG. 3A is an elevational, cross-sectional view of one suitable embodiment of the camera shown in FIG. 3. In the arrangement shown in FIG. 3A, a stationary support base 210 supports translator 101 and a first plate 220. Plate 220, in turn, supports translator 102 and a second plate 230. Each of plates 220 and 230 is in the form of a frame having an essentially hollow interior. Detector 12 may be embedded in the upper surface of base 210, or may be carried by a support member 240 that is fixed to plate 220. Carriage 20 is fixed to plate 230.

Plate 220 is displaceable along the surface of base 210 parallel to the plane of FIG. 3A by the operation of translator 101. Plate 230 is displaceable parallel to the plane of base 210, but in a direction perpendicular to the plane of FIG. 3A, by the action of translator 102.

When detector 12 is embedded in the upper surface of base 210, translators 101 and 102 act to displace carriage 20 in two mutually perpendicular directions relative to detector 12. When, on the other hand, detector 12 is carried by support member 240, detector 12 will be displaced in a first horizontal direction by the operation of translator 101 and carriage 20 will be displaced in a second horizontal direction, perpendicular to the first direction, by operation of translator 102.

According to a further embodiment of the invention, two photodetectors can be provided, one at the position of detector 12 and the other at position 12′ in FIG. 1. One detector, such as 12′, can be stationary relative to its associated lens 16, while the other detector, 12, is movable in plane P relative to its associated lens 18.

Returning to FIG. 3, frame grabber 202 includes a virtual array in which date transmitted via line 112 is stored. The data will be stored conventionally in a rectangular format, corresponding to the pattern of sensor cell locations in detector 12. Video data supplied to monitor 210 can produce two display portions, a portion D1 showing the wide field of view imaged by lens 16 and a portion D2 showing the narrow field of view imaged by lens 18. Since the data for the images to be displayed in portions D1 and D2 are obtained at different times, the data for one display portion will be stored for a selected period of time while the image for the other display portion is being generated.

Software may be provided to correlate the displays associated with the two lenses. For example, the software can allow the user to point to a certain region of display portion D1 and click on that region to cause translators 101 and 102 to bring lens 18 to a position relative to detector 12 to form an enlarged image of that region with a magnification equal to the ratio of the focal length of lens 18 to the focal length of lens 16.

Thus, the present invention provides a camera which has both a lens providing a wide field of view, such lens having a relatively short focal length, and a lens having a relatively narrow field of view and a relatively long focal length. An image of a scene can first be focused on detector 12 by the short focal length lens and then stored and/or displayed, after which detector 12 and/or carriage 20 can be moved so that a selected portion of the scene can be focused on detector 12 by the long focal length lens, and the resulting data can also be stored and/or displayed.

Detector 12 is preferably of the CCD television type, although any other suitable detector technology can be employed. In addition, one or both lenses can be mounted for movement along their respective optical axes A, A′, for focusing purposes.

If two detectors are provided, the image formed by the detector at position 12′ can provide the data for display portion D1, while the image formed by the detector at position 12 can be used to provide the data for display portion D2. This arrangement provides, in effect, two cameras in which the position of detector 12 can be adjusted while viewing the image provided by the second detector at position 12′, thereby providing a master-slave relationship.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A method of generating a video signal representing an image of a scene, comprising:
providing a photodetector having a light sensitive surface with a given area;
providing a first focusing lens;
positioning the first lens to focus an image of a scene on the photodetector so that only a portion of the image is focused on the light sensitive surface; and
effecting relative displacement between the first lens and the photodetector parallel to the light sensitive surface in order to change the portion of the image that is focused on the light sensitive surface.

2. The method of claim 1 wherein the first focusing lens has an optical axis that traverses the light sensitive surface, and said method further comprises:
providing a second focusing lens having an optical axis which traverses the light sensitive surface;
positioning the second lens to focus an image of a scene on the photodetector; and
effecting a second relative displacement between the lenses and the photodetector parallel to the light sensitive surface between a first position in which a portion of the image formed by the first lens is focused on the light sensitive surface and a second position in which at least a portion of the image formed by the second lens is focused on the light sensitive surface.

3. The method of claim 2 wherein during said step of effecting relative displacement, the first and second lenses remain fixed in position relative to one another.

4. The method of claim 3 wherein the first and second lenses have respectively different focal lengths.

5. The method of claim 4 wherein the second lens has a shorter focal length than the first lens.

6. The method of claim 5, further comprising:
selecting a portion of the scene focused by the second lens on the photodetector; and
effecting relative movement between the first lens and the photodetector to cause the first lens to focus the selected portion of the scene on the photodetector.

7. Apparatus for generating a video signal representing an image of a scene, comprising:
a photodetector having a light sensitive surface with a given area;
a first focusing lens;
means for positioning the first lens to focus an image of only a portion of a scene on the light sensitive surface; and
means for effecting relative displacement between the first lens and the photodetector parallel to the light sensitive surface in order to change the portion of the image that is focused on the light sensitive surface.

8. The apparatus of claim 7 wherein the first focusing lens has an optical axis that traverses the light sensitive surface, and said apparatus further comprises a second focusing lens having an optical axis which traverses the light sensitive surface, and wherein
said means for positioning are operative for positioning the second lens to focus an image of the entire scene on the light sensitive surface; and
said means for effecting relative displacement are operative for effecting a second relative displacement between the lenses and the photodetector parallel to the light sensitive surface between a first position in which a portion of the image formed by the first lens is focused on the light sensitive surface and a second position in which at least a portion of the image formed by the second lens is focused on the light sensitive surface.

9. The apparatus of claim 8 wherein the first and second lenses remain fixed in position relative to one another during the relative displacements.

10. The apparatus of claim 9 wherein the first and second lenses have respectively different focal lengths.

11. The apparatus of claim 10 wherein the second lens has a shorter focal length than the first lens.

12. The apparatus of claim 8 wherein said means for effecting relative displacement comprise:
a support base having a surface;
a first plate mounted on the support plate;
a first translator for displacing the first plate in a first direction parallel to the surface;
a second plate mounted on the first plate; and
a second translator for displacing the second plate in a second direction parallel to the surface and perpendicular to the first direction, wherein, the photodetector is mounted in the surface or on the first plate and the lenses are mounted on the second plate.

13. The apparatus of claim 7 further comprising,
a second photodetector having a second light sensitive surface;
a second focusing lens; and
means for positioning the second lens to focus an image of the entire scene on the second light sensitive surface.
